(19) United States
(12) Patent Application Publication
(10) Pub. No.: US 2007/0247860 A1
(43) Pub. Date: Oct. 25, 2007

(54) PIVOTING LIGHT POLE

(76) Inventors: ROBERT LEE FRANKLIN, Snellville, GA (US); William R. Cole, Pace, FL (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/737,995

(22) Filed: Apr. 20, 2007

Related U.S. Application Data
(60) Provisional application No. 60/745,327, filed on Apr. 21, 2006.

(51) Int. Cl. F21V 21/30

(52) U.S. Cl. 362/431; 362/287; 362/427

(57) ABSTRACT

A pivotable light pole apparatus comprising a first and a second pole section, a portion of the first pole section being fittable within a portion of the second pole section, with one end of each pole section being pivotably connected to each other by a pin. The apparatus further comprises a slidable cover which fits over both pole sections and locks in place when the pole sections are collinear so that the pole sections form a single pole, yet when the cover is retracted over the second pole section the first pole section can be pivoted by a technician to be generally perpendicular to the first pole section. When in the pivoted position a light fixture mounted to the first pole section is brought closer to the technician for easier inspection or repair.

### CROSS-REFERENCE TO RELATED APPLICATION

This application claims benefit of co-pending U.S. Provisional Patent Application No. 60/745,327, filed Apr. 21, 2006, entitled PIVOTING LIGHT POLE, and commonly assigned to the assignee of the present application, the disclosure of which is incorporated by reference in its entirety herein.

### FIELD OF THE INVENTION

The present application relates to poles and conduits for mounting light fixtures and which may contain wiring.

### BACKGROUND OF THE INVENTION

Billboards and their associated advertising displays which are meant to be visible at night from a distance typically use lighting fixtures which are mounted above or below the billboard. The fixture is located on a horizontal pole mounted to the billboard frame with the fixture being a distance away from the display face, in the range of about 4-6 feet, so as to provide proper dispersion and even coverage of the light across the display. When the light bulbs need replacing or the fixtures need inspection or repair, the technician must get access to the fixture. It is not safe or practicable to shimmy out the pole to the fixture, so, commonly, the technician must drive a crane or lift truck out to the billboard and be elevated in a bucket or other transport device to reach the fixture. Where the billboard is in a location which is difficult for a vehicle to traverse, it becomes problematic to conveniently access the fixtures. The need for a vehicle also increases the cost of maintenance.

Some fixtures can be accessed by a catwalk extending from the billboard; but, the technician has to dismantle at least a part of the light pole to draw the fixture at the end of the pole close enough to the catwalk to be reachable. Again, this presents problems of safety and convenience.

Several light pole apparatus have been developed which pivot or bend at some point between the two ends of the pole, but such apparatus are typically designed for vertical poles, such as a streetlight.

It would be desirable to have a horizontally mounted light pole apparatus that would pivot to enable a single technician to easily reach and manipulate the light fixture without risking safety or incurring undue effort or cost.

### SUMMARY OF THE INVENTION

The present invention generally provides, in one exemplary embodiment, a pivotable light pole apparatus comprising a first and a second pole section, a portion of the first pole being fittable within a portion of the second pole, with one end of each pole being pivotably connected to each other by a pin. The apparatus further comprises a slidable cover which fits over both poles and locks in place when the pole sections are collinear so that the pole sections form a single pole, yet when the cover is retracted over the second pole section the first pole section can be pivoted toward the technician. When in the pivoted position a light fixture mounted to the first pole section is brought closer to the technician for easier inspection or repair.

The present invention enables the technician to bring the fixture close to the technician on a catwalk so that the fixture can be accessed. The present invention obviates the need for a truck or crane to enable access to the fixtures from the ground, or, climbing out on the light pole to gain access.

### BRIEF DESCRIPTION OF THE DRAWINGS

Exemplary embodiments of the present invention is illustrated in the drawings in which like reference characters designate the same or similar parts throughout the figures of which:

FIG. 1 is a perspective schematic view of one exemplary embodiment of the present invention;

FIG. 2 is a perspective schematic view of the embodiment of FIG. 1 with the cover slid back from the pivoting section;

FIG. 3 is a perspective schematic view with the cover slid forward over the pivoting section;

FIG. 4 is a perspective schematic view showing the pole sections with the U-bolt and a block view of a light fixture;

FIG. 5 is a perspective schematic view showing the wiring in phantom

FIG. 6 is a perspective schematic view showing the light fixture; and,

FIG. 7 is a perspective schematic view showing the light fixture and an optional handle.

### DETAILED DESCRIPTION OF THE PREFERRED EMBODIMENTS

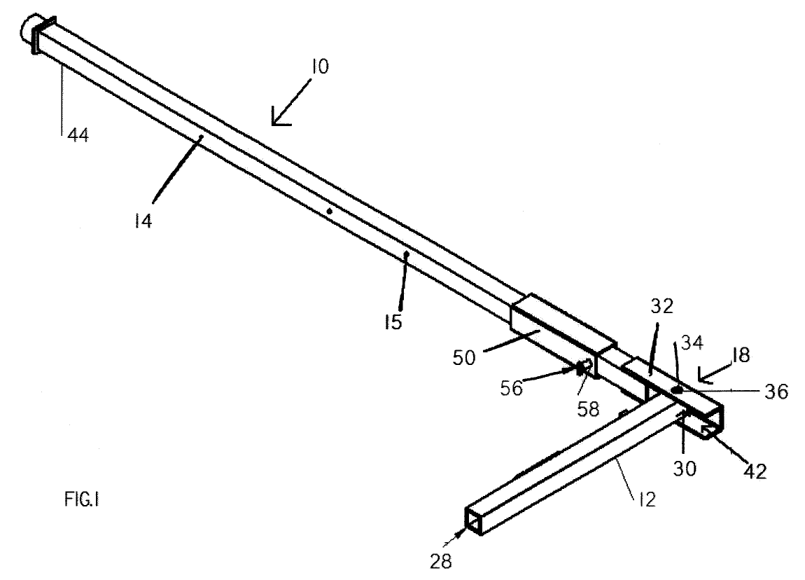

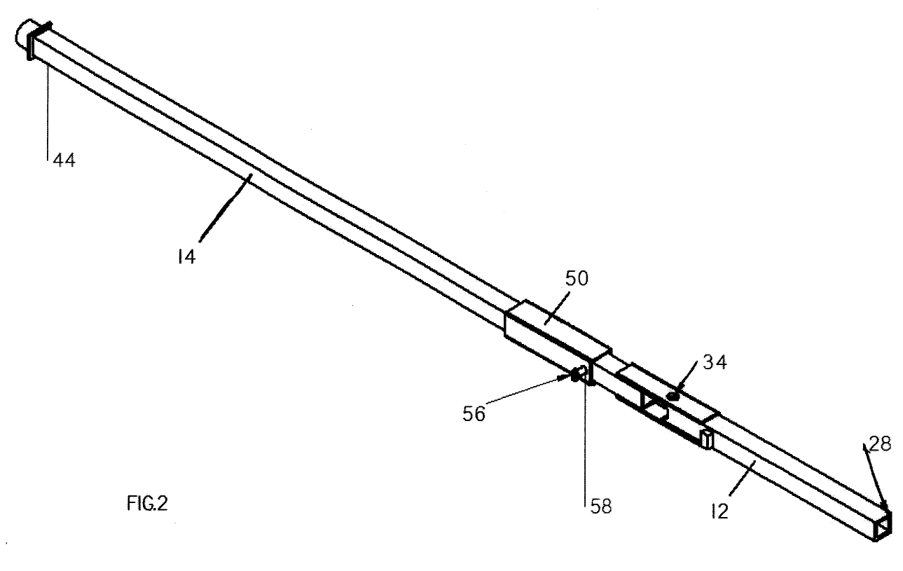

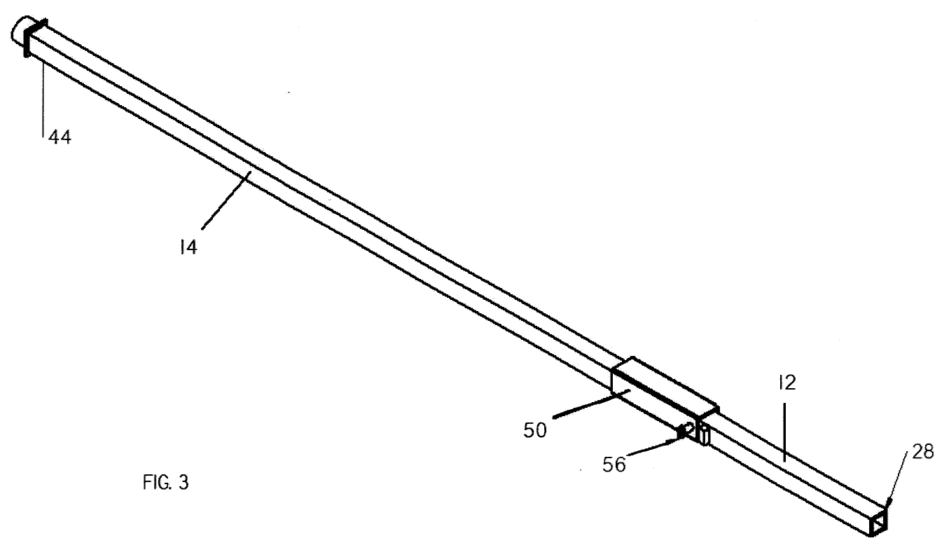

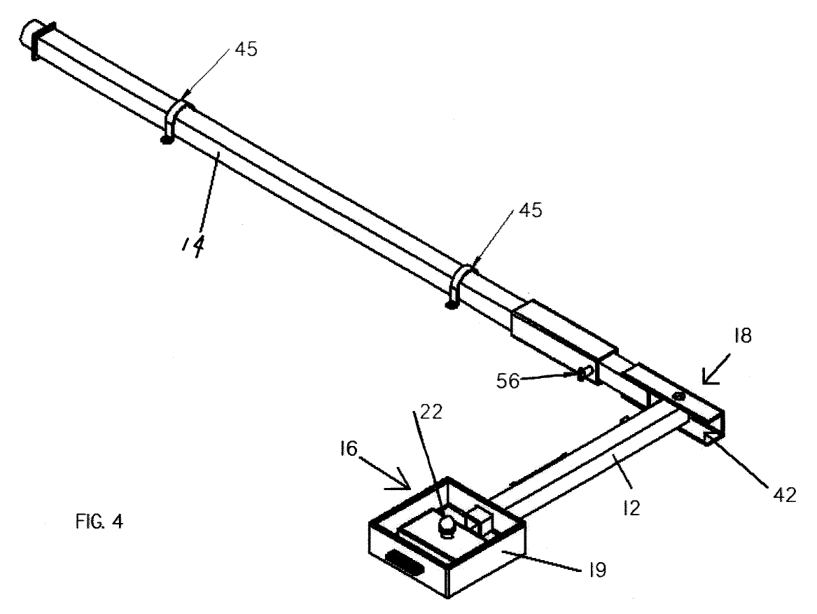

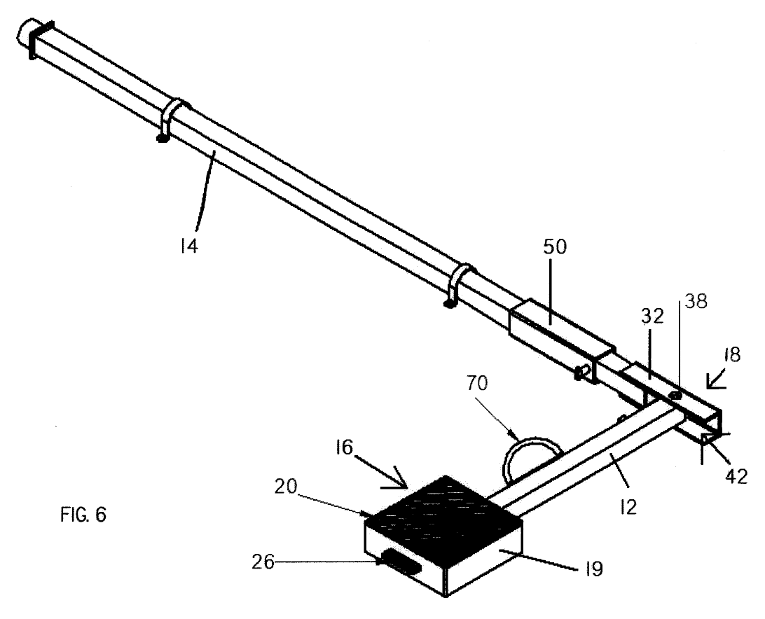

The present invention provides in one exemplary embodiment, shown in FIGS. 1-6, a light pole apparatus 10 generally comprising a first pole section 12, a second pole section 14, and a pivoting section 18. The present invention is designed to be coupled to a conventional light fixture 16. The pole sections 12, 14 are preferably composed of a rigid, durable and strong material, such as steel, alloy, plastic, composite, combinations of the foregoing and the like. The pole sections 12, 14 may be circular in cross-section, or may be square, rectangular or other geometric cross-sectional shape. The sections 12, 14 may have the same general cross-sectional shape or each may have a distinct shape. If each pole 12, 14 has a distinct cross-sectional shape, it is preferable that the portions that are pivotably connected to each other (as described in detail hereinbelow) have the same general shape for ease of interconnection. The pole sections 12, 14 are preferably hollow so as to accommodate wires. The pole sections 12, 14 may also optionally have weep holes 15 on the underside to allow water to drain. The light fixture 16 (see FIG. 6) is composed of a housing 19, transparent or translucent cover 20, bulb 22 and wiring 24, as is commonly known in the art and commercially available from a number of sources. Optionally, a handle 26 may be included. The light fixture 16 is mounted (by bolt, screw, welding or other manner commonly known in the art) to the distal end 28 of the first pole section 12.

The proximal end 30 of the first pole section 12 is connected to the distal end 32 of the second pole section 14 by a pin 34, bolt or screw, which passes through an aperture 36 in the proximal end 30 of the first pole section 12 and an aperture 38 in the distal end 32 of the second pole section. The distal end 32 of the second pole section 14 has a trough 42 or channel portion which can accommodate the proximal end 30 of the first pole section 12 when the first and second pole sections 12, 14 are aligned to be in a straight line. The second pole 14 also has a proximal end 44.

A cover 50 is slidably positioned over the second pole 14 and can move freely on the second pole 14. The cover 50 preferably has generally the same cross-sectional shape as the second pole section 14. The cover 50 preferably also includes at least one screw 56 threaded into at least one threaded hole 58 in the cover 50. The screw 56 can be tightened so that the end of the screw 56 is forced against the second pole 14 and locks the cover 50 in place. The cover 50 is slid over the pivoting section 18 and locked into place when the light pole apparatus 10 is positioned for illumination of the billboard. The cover 50 maintains the pole sections 12, 14 in a fixed relationship when in this position. The cover 50 is retracted when the first pole section 12 is pivoted. Alternatively, other mechanisms for maintaining the cover 50 in the covered or in the retracted position may be used, such as, but not limited to, a spring or wedge (not shown) positioned between the inside of the cover 50 and the pole section 14. When desired, the technician can force the cover to move by overcoming the friction or biasing of the spring. Other retention mechanisms known to those skilled in the art are contemplated as being within the scope of the present invention.

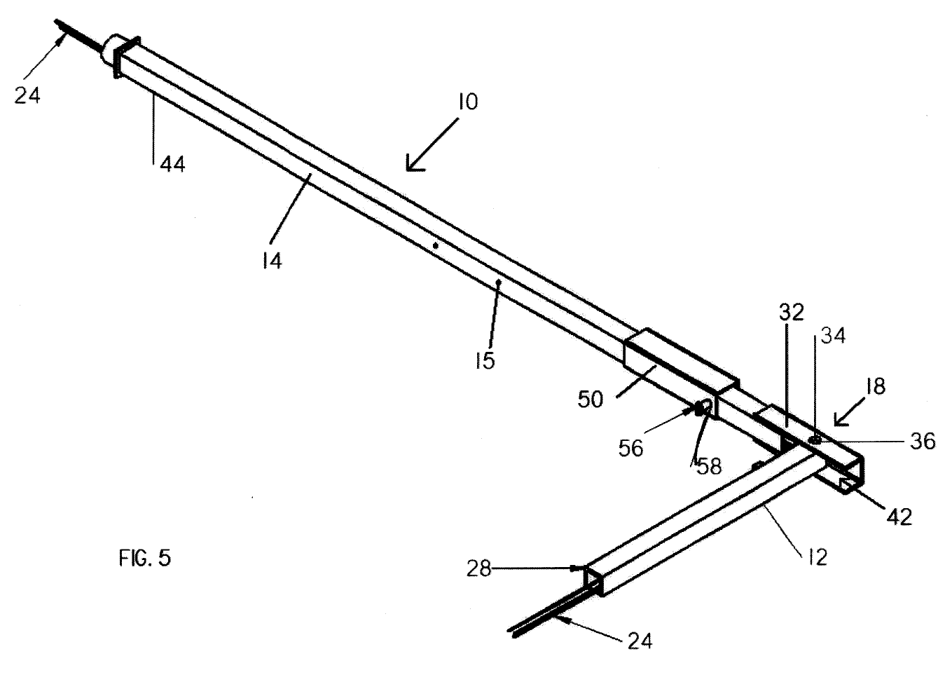

The light pole apparatus may have the wiring 24 pass from the fixture 16 through the pole sections 12, 14 and out the proximal end 44 of the second pole 14 to connect to the billboard power source. The wiring 24 preferably passes under the pin 34 as shown in FIG. 5 so that when the first pole section 12 is pivoted the wiring can flex but not be crimped.

The proximal end 44 of the second pole section 14 may be mounted to a billboard frame by U-bolts 45 or other fastening means. Alternatively, the proximal end 44 of the second pole section 14 may be inserted into a tube segment attached to the billboard frame and fastened to the billboard frame by a bolt or other attachment mechanism.

In use, the technician stands on the catwalk and accesses the light pole apparatus 10, which is in the horizontal position with the pole sections 12, 14 being collinear. The technician loosens the screw 56 (or adjusts other mechanisms, as appropriate) and slides back the cover 50. The technician can then pull the first pole section 12 and the light fixture 16 toward him/her, pivoting the first pole section 12 about the pin 34, thereby enabling the technician to access the housing 19 and the bulb 22.

Alternatively, it is possible for the technician to loosen both the securing means (e.g., U-bolt) which fastens the proximal end 44 of the second pole 14 to the billboard frame and also loosen the screw 56. The second pole section 14 is rotated (particularly if the shape of the distal end 44 is circular) and the fixture is pivoted horizontally and vertically to make accessing the fixture easier.

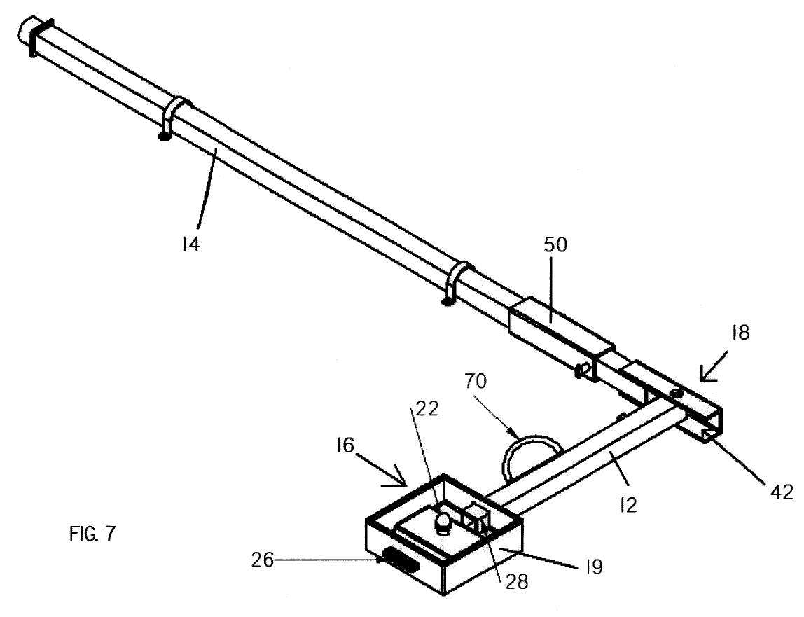

FIG. 7 shows an optional handle 70 attached to or formed as part of the pole section 12, preferably disposed proximate to the distal end 28, i.e., near the light fixture 16. The handle 70 may be used in conjunction with a hook on a hand-held pole (not shown) which is used by the technician to grab the end of the pole 12 and the light fixture 16. Alternatively, the handle 70 may be a loop or may be a slot or hole formed in the pole section 12 itself. Further, the handle 70 may alternatively be a loop or length of cord or wire attached to the distal end of the pole section 12.

An advantage of the present invention is that the pivoting feature using the cover allows the technician to safely and easily reach the fixture 16 without having to reach out over the catwalk or to use a truck or crane to reach the fixture 16. The cover 50 reduces the likelihood of dirt or moisture entering or fouling the pivoting section 16 and also locks the pole sections 12, 14 in a fixed orientation. The design of the hollow poles 12, 14 and pin 34 arrangement permits the wiring to run through the poles 12, 14 but not be crimped upon repeated pivoting movements. Further, the technician can use the handle 26 or the handle 70 to pull the fixture 16, such as by using a hook.

Although only a few exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention as defined in the following claims.

It should further be noted that any patents, applications and publications referred to herein are incorporated by reference in their entirety.

Claimed is:

1. A pivotable light pole apparatus, comprising:
a) a first pole section having a proximal end and a distal end;
b) a second pole section having a proximal end and a distal end;
c) a channel formed in said distal end of said second pole section sized to accommodate said proximal end of said first pole section;
d) a pin pivotably associating said proximal end of said first pole and said distal end of said second pole, said pin passing through said channel; and,
e) a cover slidably mounted on said second pole section, said cover comprising
i) at least one hole sized to accommodate a screw, and,
ii) at least one screw threadably disposed in said hole.

2. The apparatus of claim 1, further comprising a light fixture attached to the distal end of the first pole section.

3. The apparatus of claim 1, wherein said first and said second pole sections are hollow.

4. The apparatus of claim 1, wherein said first and said second pole sections have a generally square cross sectional shape.

5. The apparatus of claim 1, further comprising wiring disposed within said first and said second pole sections for connecting a light fixture to a source of electricity.

6. The apparatus of claim 1, further comprising a light fixture associated with said first pole section.

7. The apparatus of claim 6, further comprising a handle associated with said apparatus for manipulating said first pole section and said light fixture.

8. A method for accessing a light fixture used in billboard displays, comprising:
a) providing a pivotable light pole apparatus, comprising:
i) a first pole section having a proximal end and a distal end;
ii) a second pole section having a proximal end and a distal end;
iii) a channel formed in said distal end of said second pole section sized to accommodate said proximal end of said first pole section;
iv) a pin pivotably associating said proximal end of said first pole and said distal end of said second pole, said pin passing through said channel; and,
v) a cover slidably mounted on said second pole section, said cover comprising
a) at least one hole sized to accommodate a screw,
b) at least one screw threadably disposed in said hole; and,
vi) a light fixture associated with said second pole section;
b) sliding said cover so that said pin is exposed; and,
c) pivoting said first pole with respect to said first pole so as to draw said light fixture closer to a technician.
